(19) United States
(12) Patent Application Publication
(10) Pub. No.: US 2026/0370423 A1
(43) Pub. Date: Nov. 19, 2026

(54) INDICATION OF SEPARATE TIME AND FREQUENCY RESOURCE ELEMENT GROUP BUNDLE SIZES IN A CONTROL RESOURCE SET

(71) Applicant: QUALCOMM Incorporated, San Diego, CA (US)

(72) Inventors: Morteza SOLTANI, San Diego, CA (US); Gabi SARKIS, San Diego, CA (US); Mostafa KHOSHNEVISAN, San Diego, CA (US); Jing SUN, San Diego, CA (US); Diana MAAMARI, San Diego, CA (US)

(21) Appl. No.: 19/208,060

(22) Filed: May 14, 2025

(51) Int. Cl. H04L 5/00; H04W 24/08; H04W 72/0453

(52) U.S. Cl. CPC H04L 5/0053; H04W 24/08; H04W 72/0453

(57) ABSTRACT

This disclosure provides methods, components, devices and systems for indication of separate time and frequency resource element group bundle sizes in a control resource set (CORESET). For example, a network entity may configure time and frequency resource element group (REG) bundle sizes and corresponding precoder cycle granularities. The network entity may indicate, to a user equipment (UE) via control signaling that configures the CORESET, a quantity of time resources and a quantity of frequency resources in each REG bundle. The network entity may configure precoder cycling according to a precoder granularity that is the same as the time and frequency REG bundle size, the time REG bundle size, the frequency REG bundle size, the entire CORESET size, or any combination thereof.

### TECHNICAL FIELD

This disclosure relates generally to wireless communication, and more specifically to systems, devices, methods, and techniques associated with indication of separate time and frequency resource element group bundle sizes in a control resource set.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving control signaling configuring a control resource set (CORESET) including one or more resource element groups (REGs), where the control signaling indicates a duration of the CORESET, a time REG bundle size of the one or more REGs, and a frequency REG bundle size of the one or more REGs, monitoring, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of resource elements in a frequency domain in accordance with the frequency REG bundle size indicated via the control signaling, and receiving, in accordance with the monitoring, the one or more control signals via at least one REG bundle included in the CORESET.

A UE for wireless communications is described. The UE may include one or more memories storing processor-executable code, a transceiver, and one or more processors coupled with the one or more memories and the transceiver. The one or more processors may be configured to cause the UE to receive control signaling, via the transceiver, configuring a CORESET including one or more REGs, where the control signaling indicates a duration of the CORESET, a time REG bundle size of the one or more REGs, and a frequency REG bundle size of the one or more REGs, monitor, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of resource elements in a frequency domain in accordance with the frequency REG bundle size indicated via the control signaling, and receive, via the transceiver, in accordance with the monitoring, the one or more control signals via at least one REG bundle included in the CORESET.

Another UE for wireless communications is described. The UE may include means for receiving control signaling configuring a CORESET including one or more REGs, where the control signaling indicates a duration of the CORESET, a time REG bundle size of the one or more REGs, and a frequency REG bundle size of the one or more REGs, means for monitoring, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of resource elements in a frequency domain in accordance with the frequency REG bundle size indicated via the control signaling, and means for receiving, in accordance with the monitoring, the one or more control signals via at least one REG bundle included in the CORESET.

A non-transitory computer-readable medium storing code for wireless communications is described. The code may include instructions executable by one or more processors to receive control signaling configuring a CORESET including one or more REGs, where the control signaling indicates a duration of the CORESET, a time REG bundle size of the one or more REGs, and a frequency REG bundle size of the one or more REGs, monitor, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of resource elements in a frequency domain in accordance with the frequency REG bundle size indicated via the control signaling, and receive, in accordance with the monitoring, the one or more control signals via at least one REG bundle included in the CORESET.

In some examples of the method, UEs, and non-transitory computer-readable medium described herein, receiving the control signaling may include operations, features, means, or instructions for receiving, via the control signaling, an indication of a precoder cycling mode enabled for precoder cycling across resources within the CORESET according to a precoder cycling granularity.

In some examples of the method, UEs, and non-transitory computer-readable medium described herein, the precoder cycling mode includes a time and frequency cycling mode that enables the precoder cycling between a sequence of precoders across both the time domain and the frequency domain according to the precoder cycling granularity, the precoder cycling granularity based on both the time REG bundle size and the frequency REG bundle size.

In some examples of the method, UEs, and non-transitory computer-readable medium described herein, the precoder cycling mode includes a time cycling mode that enables the precoder cycling between a sequence of precoders across the time domain according to the precoder cycling granularity, the precoder cycling granularity based on the time REG bundle size.

In some examples of the method, UEs, and non-transitory computer-readable medium described herein, the precoder cycling mode includes a frequency cycling mode that enables the precoder cycling between a sequence of precoders across the frequency domain according to the precoder cycling granularity, the precoder cycling granularity based on the frequency REG bundle size.

In some examples of the method, UEs, and non-transitory computer-readable medium described herein, the precoder cycling mode includes an all contiguous resource cycling mode that enables the precoder cycling according to the precoder cycling granularity, the precoder cycling granularity including all contiguous time and frequency resources included in the CORESET.

In some examples of the method, UEs, and non-transitory computer-readable medium described herein, the time REG bundle size may be different from the duration of the CORESET.

### BRIEF DESCRIPTION OF THE DRAWINGS

FIG. 1 shows an example of a wireless communication system.

FIG. 2 shows an example of a signaling configuration that supports indication of separate time and frequency resource element group (REG) bundle sizes in a control resource set (CORESET).

FIG. 3 shows examples of resource configurations that support indication of separate time and frequency REG bundle sizes in a CORESET.

FIG. 4 shows an example of a process flow that supports indication of separate time and frequency REG bundle sizes in a CORESET.

FIG. 5 shows a block diagram of a processing system that supports indication of separate time and frequency REG bundle sizes in a CORESET.

FIG. 6 shows a diagram of a system including a device that supports indication of separate time and frequency REG bundle sizes in a CORESET.

FIGS. 7 through 10 show flowcharts illustrating methods that support indication of separate time and frequency REG bundle sizes in a CORESET.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a control resource set (CORESET) may be configured with some quantity of resources in time and frequency. Control channel candidates in the CORESET may include subsets of resources (e.g., control channel elements (CCEs)) via which control information may be sent, where each CCE may include some quantity of resource element groups (REGs) and the total quantity of CCEs used for a control channel candidate may be based on an aggregation level (AL) for the channel candidate. REGs may be mapped to resources in the CORESET in time first, followed by in frequency. For example, if the CORESET is three symbols long in a time domain, the AL is one, and one CCE includes six REGs, then the six REGs may be mapped to all three symbols in a first frequency resource (e.g., resource block (RB)) and then to all three symbols in a second RB, such that the resources of the control channel candidate span across at least two RBs in the frequency domain and three slots (e.g., OFDM symbols, or other transmission time intervals (TTIs)) in the time domain.

In some examples, a longer CORESET may include more symbols in the time domain to increase capacity (e.g., quantities of control messages conveyed via the CORESET), coverage (e.g., to address or be monitored by more user equipment (UEs)), or both. However, as the length of the CORESET increases, frequency diversity within each REG bundle may decrease. For example, each REG bundle may extend across all symbols of the CORESET in the time domain and a single RB in the frequency domain (e.g., instead of two or more RBs).

If the UE and network entity support precoder cycling, a sequence of precoders may be mapped to the REGs in the CORESET (e.g., the precoder cycling granularity may be the same as a control channel candidate granularity). The network entity and the UE may thereby apply a precoder for communications via a given REG based on the precoder-to-control channel candidate mapping. However, as CORESET length increases, frequency diversity of the precoders may decrease, as the REGs, and therefore the precoders, may be mapped across the time domain before the frequency domain. Additionally, or alternatively, precoders may cycle through the frequency domain but not across the time domain within the CORESET. Techniques for precoder cycling across both time and frequency irrespective of a size of the CORESET may be beneficial.

Aspects of the subject matter described in this disclosure relate to techniques for a network entity to configure time and frequency REG sizes and corresponding precoder cycle granularities. For example, instead of indicating a size of each REG and then mapping that quantity of resources to time resources first followed by mapping to frequency resources (if more than one), the network entity may explicitly indicate a quantity of time resources and a quantity of frequency resources in each REG bundle. The network entity may thereby configure each REG bundle to include some quantity of one or multiple RBs in the frequency domain, or the network entity may configure one or more different REG bundles within a same frequency resource and across symbols in the time domain, or both. The network entity may similarly configure precoder cycling according to a precoder granularity that is the same as either the time and frequency REG bundle size, the time REG bundle size, the frequency REG bundle size, the entire CORESET size, or any combination thereof.

Particular aspects of the subject matter described in this disclosure can be implemented to realize one or more of the following potential advantages. In some examples, by supporting indication of separate time and frequency REG bundle sizes in a CORESET, the described techniques can be used to enable precoder cycling with increased granularity in the time domain, the frequency domain, or both, which may enable a network entity to utilize a long CORESET to increase channel capacity, channel coverage, or both, without losing frequency diversity, among other examples. The described time and frequency REG bundle mapping and precoder cycling described herein may thereby improve reliability of communications, communication performance, and coordination between devices, among other examples.

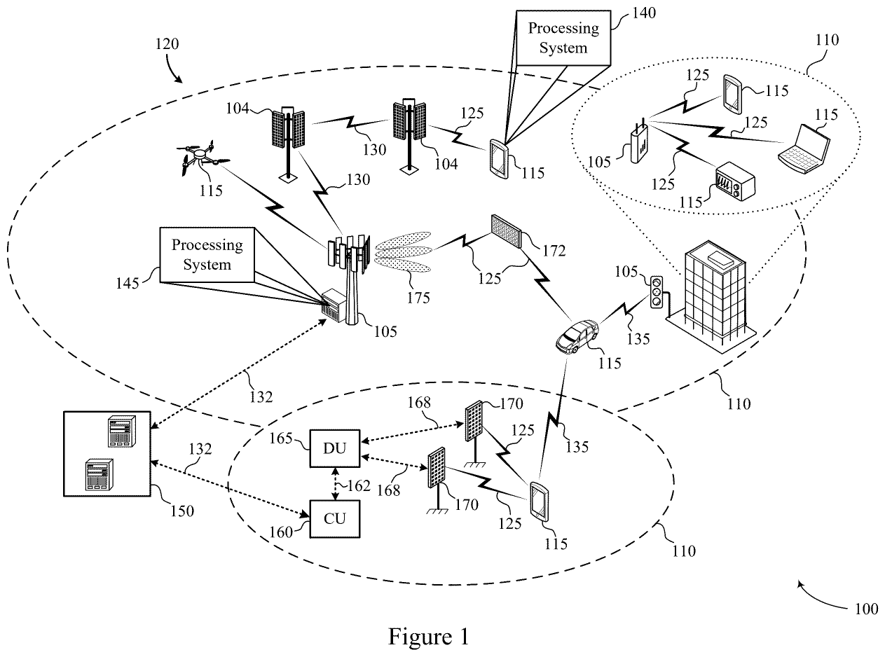

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, an RB, such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a CORESET (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for indication of separate time and frequency REG bundle sizes in a CORESET. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques for a network entity 105 to configure time and frequency REG sizes and corresponding precoder cycle granularities. For example, instead of indicating a size of each REG and then mapping that quantity of resources to time resources first followed by mapping to frequency resources (if more than one frequency resource), the network entity 105 may explicitly indicate a quantity of time resources and a quantity of frequency resources in each REG bundle. The network entity 105 may thereby configure each REG bundle to include some quantity of one or multiple RBs in the frequency domain, or the network entity 105 may configure one or more different REG bundles within a same frequency resource and across symbols in the time domain, or both. The network entity 105 may similarly configure precoder cycling according to a precoder granularity that is the same as either the time and frequency REG bundle size, the time REG bundle size, the frequency REG bundle size, the entire CORESET size, or any combination thereof. In some examples, by supporting indication of separate time and frequency REG bundle sizes in a CORESET, the described techniques can be used to enable precoder cycling in the time domain and the frequency domain, which may enable a control channel to utilize a long CORESET such that channel capacity, channel coverage, or both may be increased without losing frequency diversity, among other examples. The described time and frequency REG bundle mapping and precoder cycling described herein may thereby improve reliability of communications, communication performance, and coordination between devices, among other examples.

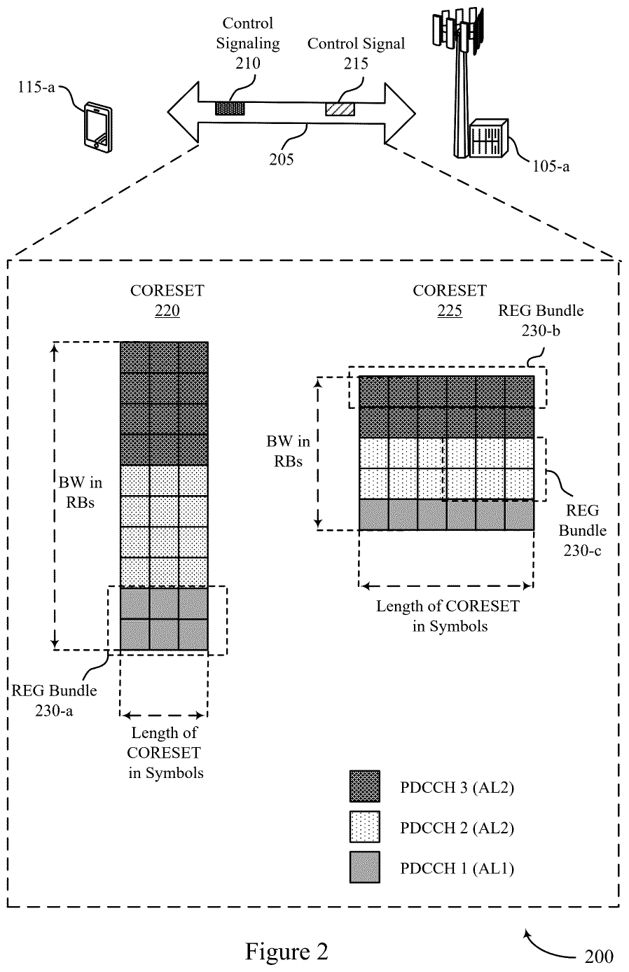

FIG. 2 shows an example of a signaling configuration 200 that supports indication of separate time and frequency REG bundle sizes in a CORESET. Aspects of the signaling configuration 200 may implement, or be implemented to realize, aspects of the wireless communications system 100, as described herein. For example, the signaling configuration 200 may include a network entity 105-a and a UE 115-b, each of which may represent examples of corresponding devices described herein with reference to FIG. 1.

In the example of the signaling configuration 200, the network entity 105-a may communicate with the UE 115-a (or vice versa) via a communication link 205. The communication link 205 may be an example of a Uu link, a sidelink, a backhaul link, a D2D link, or some other type of communication link 125 described herein with reference to FIG. 1.

In wireless communications, one or more control channel resources within a control channel (e.g., PDCCH) may be designated for communication of control information between the network entity 105-a and the UE 115-a. For example, a CORESET, including a quantity of physical resources across the time and frequency domains, may be allocated for exchange of control information. The network entity 105-a may indicate the CORESET allocations (e.g., the time and frequency resources included in a CORESET) to the UE 115-a via an RRC configuration or some other configuration, such that the UE 115-a may monitor the indicated resources for control signaling targeting the UE 115-a.

The CORESET dimensions may include a quantity of OFDM symbols (M) (e.g., the CORESET duration, the dimension in the time domain) and a quantity of RBs (X) (e.g., the dimension in the frequency domain). For example, in some cases, there may be a quantity (N) of OFDM symbols in a slot, and the CORESET duration may be up to three OFDM symbols (M∈{1, 2, 3}) (e.g., as in 5G NR), while in other cases, the CORESET duration may be greater than three OFDM symbols (e.g., as in LTE). For example, a CORESET 220 in FIG. 2 includes three OFDM symbols, while a CORESET 225 in FIG. 2 includes six OFDM symbols. The CORESET duration may be configured via RRC (e.g., as a RRC configured parameter) or via other signaling. In some cases, the frequency dimension of the CORESET may be smaller than the quantity of frequency resources for a PDSCH frequency resource allocation, where Y RBs may be allocated for PDSCH frequency domain resource assignment and X<Y.

The CORESET duration may impact timelines such as K0 (e.g., associated with the timing between a grant and a PDSCH reception), K1 (e.g., associated with feedback timing with reference to the CORESET), and K2 (e.g., associated with transmissions with respect to a PDCCH reception). The CORESET dimensions and sizes in the time domain may be selected or otherwise configured by the network entity 105-a to account for the timelines.

In some examples, a long CORESET may include more symbols in the time domain to increase capacity (e.g., quantities of control messages conveyed via the CORESET), coverage (e.g., more UEs that may be targets of control information in the CORESET), or both, as compared with shorter CORESETs. For example, a long CORESET may include more than three OFDM symbols, where the long CORESET may include up to all OFDM symbols in a slot (M∈{4, . . . , N}), or some other quantity of symbols, slots, or both. A long CORESET may increase the capacity of the channel. For example, for TDD midbands, the long CORESET may have increased capacity for a larger quantity of ALs within the long CORESET (e.g., as compared to a CORESET of three OFDM symbols). That is, a greater quantity of lower-level ALs (e.g., AL1s, where AL=one) may be packed within the long CORESET, thereby increasing capacity. In some examples, a long CORESET may increase capacity for cross carrier frequency selective implementation with control on lower bands.

Additionally, or alternatively, a long CORESET may increase the coverage of a channel. For example, larger ALs may be supported and more UEs 115 may use the large ALs in a long CORESET as compared with a CORESET having a shorter duration in the time domain. Such increases in CORESET duration and corresponding coverage may be beneficial for low-power wide-area devices, enhanced mobile broadband and extended reality technologies, devices operating in a low-power mode, or any combination thereof, among other examples.

Control channel candidates in the CORESET may include subsets of resources (e.g., CCEs) via which control information may be sent, where each CCE may include some quantity of REGs and the total quantity of CCEs used for a channel candidate may be based on an AL for the channel candidate. Control channel candidates may also be referred to as PDCCH candidates in some examples herein. In some examples, a PDCCH candidate within a CORESET may be associated with an AL, where each AL indicates a quantity (e.g., unique quantity) of CCEs (e.g., AL1 may have one CCE, AL2 may have two CCEs, and the like). For example, an AL for a control channel may include a quantity of CCEs, which may correspond to a quantity of REGs (e.g., defined as six REGs per CCE in 5GNR). In some cases, a CCE may include six REGs, where each REG may include 12 REs in one OFDM symbol and one RB. As an example, an AL may be set to one and a thus be associated with six REGs, while an AL set to two may be associated with 12 REGs.

In some examples, REGs may be mapped to resources in the CORESET in time first, followed by in frequency. For example, if the CORESET is three symbols long in a time domain, the AL is one, and one CCE includes six REGs, then the six REGs may be mapped to all three symbols in a first frequency resource (e.g., RB) and then to all three symbols in a second RB, such that the resources of the control channel candidate spans across at least two RBs in the frequency domain and three OFDM slots in the time domain.

In some cases, there may be two formats for mapping the control resources (such as the REGs) to the physical resources in the CORESET: contiguous mapping and interleaved mapping. In contiguous mapping, control resources may be contiguously mapped to CORESET physical resources, and information may be contiguously read out from an encoder. In interleaved mapping, control resources may be first interleaved (e.g., by a block-interleaver) and then mapped to the physical resources in the CORESET. In interleaved mapping, information may be written by row and read out by column, and the resources may be grouped by REG bundles.

In some examples, REG bundles may be used in mapping the control resources to the physical resources of the CORESET in time and frequency, where sets of one or more REGs may be grouped into REG bundles. In such examples, a REG bundle may be used to determine the unit for channel estimation. For example, a precoder may operate according to a specific granularity (e.g., a CORESET configuration parameter) determined by the REG bundle (e.g., precoderGranularity=sameAsREG-bundle). In such examples, the precoder may change for each REG bundle (e.g., each REG bundle may have a different precoder, and the precoder for a REG bundle may cycle through the resources of the associated REG bundle). The precoder implementation may be transparent to the UE.

In some other examples, the precoder may operate according to a granularity where the same precoder may be applied to the set of RBs in the CORESET 220 (e.g., precoderGranularity=allContiguousRBs). That is, the same precoder may be applied in the frequency domain. As such, when the precoder granularity is determined by the REG bundle (e.g., REG bundle 230-a), where one precoder may be mapped per REG bundle, the precoder may harvest resource diversity (e.g., frequency diversity) and may improve the blocked error rate (BLER) performance of corresponding communications.

In some cases, such as when the PDCCH CORESET 220 is relatively short in duration (e.g., up to three OFDM symbols), the REG bundle size may be two, three, or six REGs when interleaved mapping is used, and six REGs when the contiguous (e.g., non-interleaved) mapping is used, among other examples. However, as the length of the CORESET increases, such as in CORESET 225, frequency diversity within each REG bundle 230 may decrease. For example, because resources in each REG bundle 230 may be mapped across time first and then frequency when an AL and REG bundle size is configured (e.g., where REG bundle size indicates a total quantity of REGs in a bundle), each REG bundle (e.g., REG bundle 230-b) may extend across all symbols of the CORESET in the time domain and a single RB in the frequency domain (e.g., instead of two or more RBs), or a relatively smaller quantity of RBs in the frequency domain than if the CORESET includes fewer time domain resources. That is, with long PDCCH CORESET (e.g., when the CORESET duration is greater than three OFDM symbols as in CORESET 225), each PDCCH AL candidate (e.g., control cannel candidate) may be narrower in the frequency domain and longer in the time domain as compared with PDCCH AL candidates in shorter CORESETs (e.g., CORESET 220).

With reference to FIG. 2, the signaling configuration 200 illustrates the CORESET 220 with a duration of three OFDM symbols, and the CORESET 225 with a duration of six OFDM symbols. In this example, both the CORESET 220 and the CORESET 225 illustrate example PDCCH candidate mappings and channel estimation granularities when a non-interleaved CCE-to-REG mapping is used (e.g., with one CCE corresponding to six REGs), the REG bundle size is six, and the precoder granularity is dependent on the REG bundle (e.g., sameAsREG-bundle). In this example, if the six REGs of a REG bundle 230 are mapped to resources in the CORESETs 220 and 225 in time first, followed by frequency, then the precoder granularity may be represented as an REG bundle 230-a in the CORESET 220 and may be mapped to three OFDM symbols in time and two RBs in frequency. In the CORESET 225, the precoder granularity may be represented as an REG bundle 230-b that is mapped to six OFDM symbols in time and a single RB in the frequency domain. As such, the CORESET 220 may have a precoder granularity of two RBs in the frequency domain, while the CORESET 225 may have a precoder granularity of one RB in the frequency domain (e.g., which may reduce the precoder frequency diversity). That is, with a long CORESET (e.g., the CORESET 225), when the precoding granularity is determined by REG bundle 230 (e.g., the same as REG bundle), and REG bundles are mapped across time first followed by frequency, diversity may be reduced, which may impact PDCCH performance (e.g., when precoding occurs exclusively along the frequency domain). With a long CORESET (e.g., the CORESET 225), PDCCH candidates may be narrower in the frequency domain but longer in the time domain. As such, frequency diversity through precoder cycling may not be harvested with a long CORESET (e.g., when precoder cycling occurs only along the frequency domain).

For example, for precoder cycling in the frequency domain, if the REG bundle size is six and “precoderGranularity=sameAsREG-bundle”, then the time domain resources in REG bundle 230-b may be the same as the CORESET 225 duration (e.g., six in this case), and the frequency domain resources of REG bundle 230-b may span one RB. As a result, the precoder may cycle the RBs in the CORESET 225 and may not change (cycle) across time domain. Such precoder cycling every RB in the CORESET 225 may result in poor frequency diversity harvested by the precoder.

However, the techniques described in more detail in the present disclosure provide for indication of REG bundle sizes and corresponding precoder cycling granularities in both the time and frequency domains (instead of a single size being mapped to time first, followed by frequency). The described techniques may thereby provide for precoders to cycle across both the frequency domain and the time domain (e.g., two-dimensional precoder cycling) within a long CORESET, such as the CORESET 225. That is, techniques for precoder cycling across both time and frequency irrespective of a size of the CORESET may be described herein.

The present disclosure proposes techniques for the network entity 105-a to configure time and frequency REG bundle sizes and corresponding precoder cycle granularities. That is, instead of indicating a size of each REG bundle 230 and then mapping that quantity of resources (e.g., in the REG bundle as indicated by the REG bundle size) to time resources first followed by mapping to frequency resources (if more than one), the network entity 105-a may explicitly indicate a quantity of time resources and a quantity of frequency resources in each REG bundle 230. The network entity 105-a may thereby configure each REG bundle 230 to include some quantity of one or multiple RBs in the frequency domain, or the network entity 105-a may configure one or more different REG bundles 230 within a same frequency resource and across symbols in the time domain, or both. The network entity 105-a may similarly configure precoder cycling according to a precoder granularity that is the same as either the time and frequency REG bundle size, the time REG bundle size, the frequency REG bundle size, the entire CORESET size, or any combination thereof.

In some examples, to support a precoder cycling across the frequency domain and the time domain, the UE 115-a may receive control signaling 210 configuring a CORESET (e.g., the CORESET 225) including one or more REGs, where the control signaling 210 indicates a duration of the CORESET 225, a time REG bundle size of the one or more REGs, and a frequency REG bundle size of the one or more REGs.

In some examples, the UE 115-a may monitor, in accordance with the control signaling 210, for one or more control signals 215 during the one or more REGs within the CORESET 225, where each REG bundle (e.g., REG bundle 230-b or REG bundle 230-c, or other REG bundles not shown) may include a first quantity of resources in a time domain in accordance with the time REG bundle size indicated via the control signaling and a second quantity of REs in a frequency domain in accordance with the frequency REG bundle size indicated via the control signaling. That is, the REG bundle size may be signaled via a time bundle size and a frequency bundle size (e.g., such that REG Bundle Size=Time Bundle Size×Frequency Bundle Size). In some examples, the time bundle size and the frequency bundle size may be signaled as part of the CORESET 225 configuration parameters via an RRC message.

In some examples, the time bundle size may be the same as the CORESET duration. In some examples, the REG bundle size (e.g., “REG Bundle Size”) and duration of the CORESET 225 (e.g., “CORESET Duration”) may be signaled as part of the CORESET 225 configuration parameters via RRC. In one example, when the time bundle size is the same as the duration of the CORESET 225 (e.g., “Time Bundle¿CORESET Duration”), the frequency bundle size may be determined by the above equation (e.g., which in some cases may determine the precoder granularity in the frequency domain). In some examples, when “Time Bundle¿CORESET Duration” for a long CORESET 225, precoder cycling may occur across frequency and not across time. For example, a REG bundle 230, such as the REG bundle 230-b, may include six symbols in the time domain and one RB in the frequency domain, such that the precoders may cycle across RBs (e.g., in the frequency domain), but not symbols (e.g., in the time domain), if mapped to REG bundle 230-b. Additionally, or alternatively, as described herein, possibilities for “Time Bundle Size” may be used other than “CORESET Duration,” which may increase the resource diversity harvested from the precoder cycling.

In some examples, the network entity 105-a may convey, via the control signaling 210, an indication of the precoder granularity (e.g., “precoderGranularity”) in both the time domain and the frequency domain. For example, with a six OFDM symbol CORESET (e.g., the CORESET 225), a time bundle size may be three while a frequency bundle size may be two, such as the REG bundle 230-c in FIG. 2. With precoder cycling in the time domain and precoder cycling in the frequency domain, when both time bundle size and frequency bundle size are indicated, if the precoder granularity is the same as the time frequency bundle (e.g., “precoderGranularity=sameAsTimeFreqBundle”), then the precoder may cycle the two RBs and three symbols (e.g., cycling in both the time domain and the frequency domain).

As described herein, in some examples the network entity 105-a may indicate, via the control signaling 210, a mode (e.g., precoder cycling mode) associated with the precoder granularity. The precoder cycling mode may enable precoder cycling in only time, precoder cycling in only frequency, precoder cycling in both time and frequency, or precoder cycling in neither time nor frequency. In some examples, the CORESET configuration parameter “precoderGranularity” may be set to indicate the precoder cycling mode. In some examples, the precoder cycling mode may be signaled via RRC as part of the CORESET configuration parameters. For example, the UE 115-a may receive control signaling 210 including an indication of a precoder cycling mode enabled for precoder cycling across resources within the CORESET according to a precoder cycling granularity.

A first example precoder cycling mode may be an example of a time and frequency cycling mode that enables precoder cycling over a sequence of precoders across both the time domain and the frequency domain according to the precoder cycling granularity, where the precoder cycling granularity may be based on (e.g., the same as) the time REG bundle size and the frequency REG bundle size (e.g., precoderGranularity=sameAsTimeFreq-Bundle).

Additionally, or alternatively, a second precoder cycling mode may be an example of a time cycling mode that enables precoder cycling over a sequence of precoders across the time domain according to the precoder cycling granularity, where the precoder cycling granularity may be based on (e.g., the same as) the time REG bundle size (e.g., precoderGranularity=sameAsTime-Bundle). In such cases, the precoders may cycle over the sequence in the time domain and may not cycle in the frequency domain (e.g., all contiguous RBs may have the same precoder).

Additionally, or alternatively, a third precoder cycling mode may be an example of a frequency cycling mode that enables precoder cycling over a sequence of precoders across the frequency domain according to the precoder cycling granularity, where the precoder cycling granularity may be based on (e.g., the same as) the frequency REG bundle size (e.g., precoderGranularity=sameAsFreq-Bundle). In such cases, the precoder may cycle in the frequency domain and not cycle in the time domain (e.g., all contiguous CORESET OFDM symbols may have the same precoder).

Additionally, or alternatively, a fourth precoder cycling mode may be an example of an all contiguous resource cycling mode that enables the precoder cycling according to the precoder cycling granularity, where the precoder cycling granularity may include all contiguous time and frequency resources included in the CORESET 225 (e.g., precoderGranularity=allContiguousSymbolsAndRBs). In such cases, the precoder may neither cycle in the time domain nor the frequency domain (e.g., the precoder may be the same for all resources in the CORESET 225).

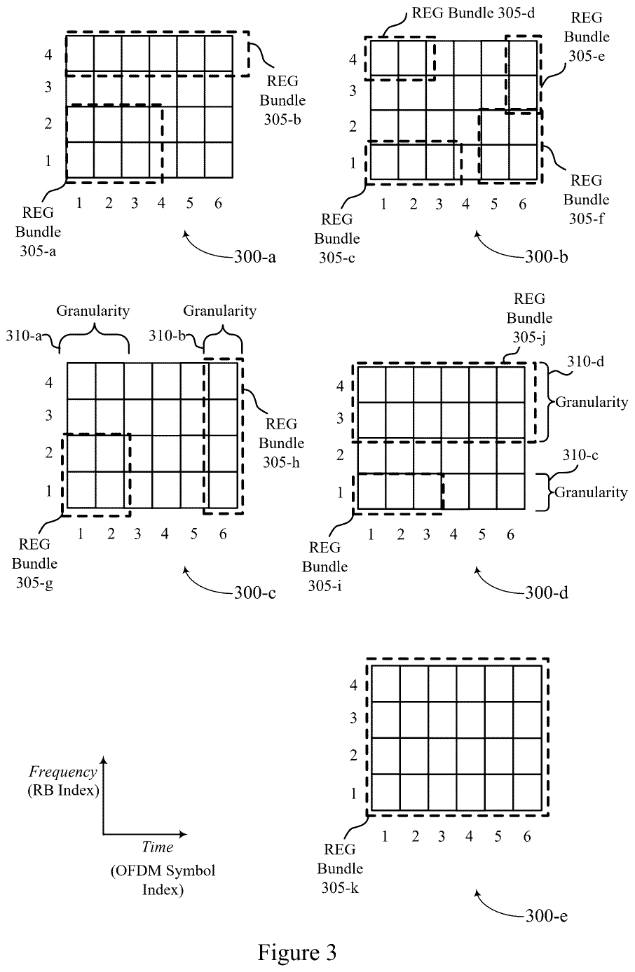

Examples of each of the four example precoder cycling modes are discussed in further detail elsewhere herein, including with respect to FIG. 3.

The UE 115-a may thereby receive the control signaling 210 that indicates the REG bundle sizes and corresponding precoder cycling modes. The UE 115-a may monitor resources in the CORESET 225 according to the indicated configurations. The UE 115-a may receive a control signal 215 (e.g., DCI, or some other control information) via at least one REG bundle 230 included in the CORESET 225 in accordance with the monitoring and the indicated precoder(s).

In some cases, the REG bundles 230 of a CORESET may include RBs with DMRS (e.g., 25% DMRS) or both RBs with DMRS and RBs without DMRS. In some cases (e.g., when the time REG bundle size is three and the frequency REG bundle size is two), the UE 115-a may extract a DRMS signal from the designated REG bundle 230 every two RBs and every three OFDM symbols. The UE 115-a may perform a channel estimation, perform an equalization procedure, attempt to decode, and move to the next batch of RBs (e.g., in the REG bundle 230) until the UE 115-a has exhausted the CORESET 225 (e.g., monitored or otherwise processed all REG bundles 230 in the CORESET 225).

In some examples, increased gain may be harvested from a long CORESET when precoder cycling occurs in both the time domain and the frequency domain. For example, by supporting indication of separate time and frequency REG bundle sizes in a CORESET, the described techniques can be used to enable precoder cycling with increased granularity in the time domain, the frequency domain, or both, which may enable a network entity 105 to utilize a long CORESET to increase channel capacity, channel coverage, or both, without losing frequency diversity, among other examples.

FIG. 3 shows example resource configurations 300 that support indication of separate time and frequency REG bundle sizes in a CORESET. Aspects of the resource configurations 300-a, 300-b, 300-c, 300-d, and 300-e may implement, or be implemented to realize, aspects of the wireless communications system 100 and the signaling configuration 200 as described herein. For example, the resource configurations 300 illustrate example configurations of resources within a CORESET used for exchange of control signaling between a UE 115-b, a network entity 105-b, or both, which may represent examples of corresponding devices as described with reference to FIGS. 1 and 2.

As described with reference to FIG. 2, a unit of channel estimation (e.g., precoder granularity) for PDCCH communications via a CORESET may, in some examples, be based on (e.g., the same as, mapped to) groups of resources in the CORESET (e.g., REG bundles). The unit of channel estimation may be determined based on one or more parameters indicated via a configuration of the CORESET (e.g., a CORESET configuration in RRC signaling). In some examples, the unit of channel estimation (e.g., precoder granularity) may be determined based on a size of a REG bundle 305 in both the time domain and the frequency domain. The example resource configurations 300-a through 300-e provide examples of different REG bundle sizes and corresponding precoder cycling granularities associated with precoder cycling in the time domain and the frequency domain, only the time domain, only the frequency domain, or in neither the time domain nor the frequency domain. As described herein, a UE 115 may be configured with parameters (e.g., time bundle size, frequency bundle size, mode, or any combination thereof) such that the gain obtained via channel estimation by the UE 115 may be optimized or otherwise increased.

In the example resource configuration 300-a, a long CORESET (e.g., with a duration of six OFDM symbols) may be associated with a time and frequency cycling mode (e.g., precoderGranularity=sameAsTimeFreq-Bundle). The REG bundle 305-a may represent the precoder granularity when the time bundle size is three and the frequency bundle size is two. In this example, the precoders may cycle across REG bundles 305 having the three symbols in the time domain and the two RBs in the frequency domain. Additionally, or alternatively, the REG bundle 305-b may represent the precoder granularity when the time bundle size is six and the frequency bundle size is one. In this example, the precoders may cycle across REG bundles 305 having the six symbols in the time domain and the one RB in the frequency domain. The network entity 105 may thereby indicate explicit time and frequency sizes for REG bundles 305 within the CORESET, and may enable a precoder cycling mode according to the time and frequency REG bundle 305 sizes.

If, however, the network entity 105 does not explicitly indicate both the time and frequency sizes for a REG bundle 305, then the REG bundle 305 may be mapped to time resources first, followed by frequency resources until the total quantity of resources designated by the REG bundle size are mapped. In such examples, the precoder may cycle across the RBs in the frequency domain of the REG bundle 305 and may not harvest the gains associated with the resource diversity available in the time domain.

The example resource configuration 300-b illustrates a long CORESET (e.g., having a duration of six OFDM symbols) that may be associated with a time and frequency cycling mode (e.g., precoderGranularity=sameAsTimeFreq-Bundle). The resource configuration 300-b illustrates multiple example REG bundle sizes in the time and frequency, and corresponding precoder cycling granularities.

For example, the REG bundle 305-c may represent a precoder granularity when the time bundle size is three and the frequency bundle size is one. In this example, the precoders may cycle across REG bundles 305 having the three symbols in the time domain and the one RB in the frequency domain. The REG bundle 305-d may represent a precoder granularity when the time bundle size is two and the frequency bundle size is one. In this example, the precoders may cycle across REG bundles 305 having the two symbols of the time domain and the one RB in the frequency domain, harvesting the resource diversity in both the time domain and the frequency domain. The REG bundle 305-e may represent a precoder granularity when the time bundle size is one and the frequency bundle size is two. In this example, the precoders may cycle across REG bundles 305 having the one symbol of the time domain and the two RBs in the frequency domain, harvesting the resource diversity in both the time domain and the frequency domain. The REG bundle 305-f may represent a precoder granularity when the time bundle size is two and the frequency bundle size is two. In this example, the precoders may cycle across REG bundles 305 having the two symbols of the time domain and the two RBs in the frequency domain, harvesting the resource diversity in both the time domain and the frequency domain. The network entity 105 may thereby indicate explicit time and frequency sizes for REG bundles 305 within the CORESET, and may enable a precoder cycling mode according to the time and frequency REG bundle 305 sizes. Although six example REG bundle sizes are illustrated in the resource configurations 300-a and 300-b, it is to be understood that the network entity 105 may configure any combination of time and frequency sizes for REG bundles 305 within a CORESET. If the network entity 105 enables precoder cycling according to both the time and frequency granularities of the REG bundles 305, the network entity 105 and the UE 115 may communicate using precoders mapped to each respective REG bundle 305 accordingly.

In the example resource configurations 300-a and 300-b, when the precoder cycling mode is the time and frequency cycling mode, the precoder cycling granularities may be the same as the granularity or sizes of each of the REG bundles 305. In some other examples described herein, the network entity 105 may enable a precoder cycling mode in only time or only frequency, or in neither time nor frequency, and the granularities for precoder cycling may differ from the sizes of the REG bundles 305.

The example resource configuration 300-c illustrates a long CORESET (e.g., with a duration of six OFDM symbols) that may be associated with a time cycling mode (e.g., precoderGranularity=sameAsTime-Bundle). In this example, the network entity 105 may indicate, via the control signaling, REG bundle sizes in time and frequency. The network entity 105 may additionally enable the precoder cycling according to the time cycling mode, such that the precoder cycling granularity 310 may be the same as the time size of each REG bundle 305. In this example, the precoders may not cycle in frequency.

In the example of the resource configuration 300-c, the REG bundle 305-g may be defined such that the time bundle size is two and the frequency bundle size is two. In this example, when time precoder cycling is enabled, the precoder may cycle according to the time bundle size of the REG bundle 305-g. That is, the precoder granularity 310-a may be the same as the time size of each REG bundle 305-g. In this example, the precoder may cycle every two symbols of the CORESET in the time domain, harvesting the resource diversity in the time domain. If another REG bundle (not pictured in FIG. 3) includes symbols RBs 4 and 3 of the CORESET in the first two OFDM symbols (symbols 1 and 2), the other REG bundle may be associated with the same precoder as the REG bundle 305-g in accordance with the precoder cycling across time and not across frequency (e.g., the precoder is the same for all RBs in the symbols 1 and 2).

As another example, the REG bundle 305-h may be defined such that the time bundle size is one and the frequency bundle size is four. In this example, the precoder may cycle according to the time bundle size of the REG bundle 305-h, where the precoder granularity 310-b is one based on the time bundle size being one. In this example, the precoder may cycle every one symbol of the time domain.

The example resource configuration 300-d illustrates a long CORESET (e.g., with a duration of six OFDM symbols) that may be associated with a frequency cycling mode (e.g., precoderGranularity=sameAsFreq-Bundle). In this example, the network entity 105 may indicate, via the control signaling, sizes of each REG bundle 305 in frequency and time. The network entity 105 may enable the precoder cycling according to the frequency cycling mode, such that the precoder cycling granularity may be the same as the frequency size of each REG bundle 305. In this example, the precoders may not cycle in time.

In the example of the resource configuration 300-d, the REG bundle 305-i may may be defined such that the time bundle size is three and the frequency bundle size is one. In this example, if the network entity 105 enables precoder cycling in the frequency domain, the precoder may cycle according to the frequency bundle size of the REG bundle 305-i, where the precoder granularity 310-c is one in accordance with the frequency size of the REG bundle 305-i being one. In this example, the precoder may cycle every one RB of the frequency domain, harvesting the resource diversity in the frequency domain. If another REG bundle (not pictured in FIG. 3) includes symbols 4, 5, and 6 of the CORESET in the first RB (RB 1), the other REG bundle may be associated with the same precoder as the REG bundle 305-i in accordance with the precoder cycling across frequency and not across time (e.g., the precoder may be the same for all symbols in the RB 1).

As another example, the REG bundle 305-j may be defined such that the time bundle size is six and the frequency bundle size is two. In this example, the precoder may cycle according to the frequency bundle size of the REG bundle 305-j, where the precoder granularity is the granularity 310-d. In this example, the precoder may cycle every two RBs of the frequency domain, harvesting the resource diversity in the frequency domain.

The example resource configuration 300-e illustrates a long CORESET (e.g., with a duration of six OFDM symbols) that may be associated with an all contiguous resource cycling mode (e.g., precoderGranularity=allContiguousSymbolsAndRBs). The REG bundle 305-k may represent the precoder granularity in such cases. In this example, the precoder may be applied to all contiguous RBs in the CORESET (e.g., there may not be precoder cycling across time or frequency).

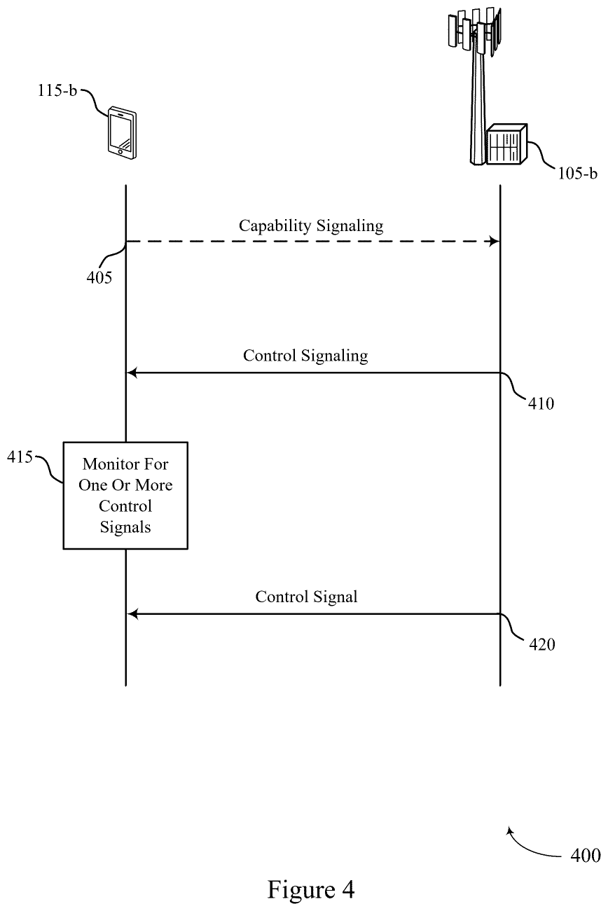

FIG. 4 shows an example of a process flow 400 that supports indication of separate time and frequency REG bundle sizes in a CORESET. Aspects of the process flow 400 may implement, or be implemented to realize, aspects of the wireless communications system 100, the signaling configuration 200, and the resource configuration 300 as described herein. For example, the process flow 400 may be implemented by a UE 115-b and a network entity 105-b, which may be examples of a UE 115 or a network entity 105, as described with reference to FIGS. 1 through 3.

In the following description of the process flow 400, the operations between the devices may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may occur at the same time. The techniques described in the context of the process flow 400 may support indication of separate time and frequency REG bundle sizes in a CORESET.

At 405, a UE 115-b may transmit capability signaling. In some cases, the UE 115-b may transmit a capability message (e.g., at 405) indicating a capability of the UE 115-b to perform granular precoder cycling across the time domain and the frequency domain. In such examples, the control signaling (e.g., at 410) may be based on, or conditioned on the capability message.

Additionally, or alternatively, the UE 115-b may transmit a capability message (e.g., at 405) indicating a capability of the UE 115-b to monitor the one or more REGs according to both the time REG bundle size and the frequency REG bundle size, where the control signaling may be based on, or conditioned on the capability message.

At 410, the UE 115-b may receive control signaling (e.g., control signaling 210) configuring a CORESET, where the CORESET may include one or more REGs. In such cases, the control signaling may indicate a duration of the CORESET, a time REG bundle size (e.g., of the one or more REGs), and a frequency REG bundle size (e.g., of the one or more REGs). The time REG size may be the same as the duration of the CORESET, or different than the duration of the CORESET. In some examples, the control signaling received at 410 may be RRC signaling, where the RRC signaling may configure the CORESET indicate one or more parameters of the CORESET. In some examples, the CORESET may include more resource elements in the time domain than in the frequency domain (e.g., a long CORESET). In some cases, the control signaling transmitted by the network entity 105-b at 410 may be based on or in response to the capability signaling at 405.

In some cases, the UE 115-b may receive control signaling (e.g., at 410) including an indication of a precoder cycling mode enabled for precoder cycling across resources within the CORESET according to a precoder cycling granularity.

In some examples, the precoder cycling mode may include a time and frequency cycling mode that enables the precoder cycling between a sequence of precoders across both the time domain and the frequency domain according to the precoder cycling granularity. Such precoder cycling granularity may be based on the time REG bundle size and the frequency REG bundle size. For example, the precoder cycling granularity may be in accordance with a time REG bundle size and a frequency REG bundle size.

Additionally, or alternatively, in some examples the precoder cycling mode may include a time cycling mode that enables the precoder cycling between a sequence of precoders across the time domain according to the precoder cycling granularity. In such cases, the precoder cycling granularity may be based on the time REG bundle size. For example, the precoder cycling granularity may be in accordance with a time REG bundle size.

Additionally, or alternatively, in some examples the precoder cycling mode may include a frequency cycling mode that enables the precoder cycling between a sequence of precoders across the frequency domain according to the precoder cycling granularity. In such cases, the precoder cycling granularity may be based on the frequency REG bundle size. For example, the precoder cycling granularity may be in accordance with a frequency REG bundle size.

Additionally, or alternatively, In some examples, the precoder cycling mode may include an all contiguous resource cycling mode that enables the precoder cycling according to the precoder cycling granularity. In such cases, the precoder cycling granularity may include all contiguous time and frequency resources included in the CORESET.

At 415, the UE 115-b may monitor for one or more control signals during the one or more REGs within the CORESET. Each REG of the one or more REGs in the CORESET may include a quantity of resources in a time domain (e.g., a first quantity of resources that are in the time domain in accordance with the time REG bundle size indicated via the control signaling at 410) and quantity of REGs in a frequency domain (e.g., a second quantity of resource elements in a frequency domain in accordance with the frequency REG bundle size indicated via the control signaling at 410). In some cases, the UE 115-b may monitor for one or more control signals based on or in response to the control signaling at 410.

At 420, the UE 115-b may receive one or more control signals (e.g., control signal 215) via at least one REG bundle included in the CORESET in accordance with the monitoring at 415. In some cases, the control signal may be based on the capability signaling at 405.

In some examples, the UE 115-b may apply a precoder to the one or more control signals. The precoder may be selected from a sequence of precoders in accordance with a mapping between the sequence of precoders and one or more resource elements included in the CORESET and a precoder cycling granularity. The mapping may indicate that the precoder is mapped to the at least one REG bundle via which the one or more control signals are received (e.g., at 420).

In some examples, each precoder of the sequence of precoders may be mapped to a respective time resource of one or more time resources in the CORESET, to a respective frequency resource of one or more frequency resources in the CORESET, or to both in accordance with the precoder cycling granularity.

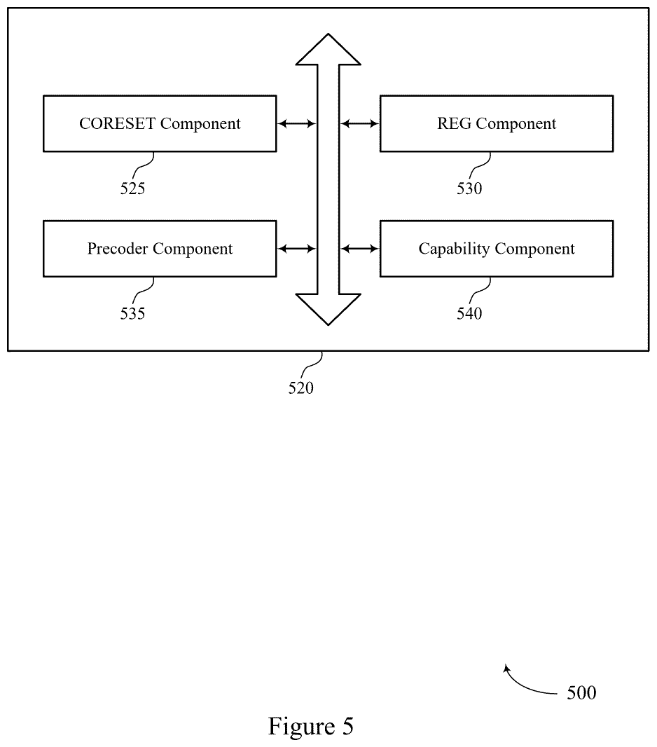

FIG. 5 shows an example 500 of a processing system 520 that supports indication of separate time and frequency REG bundle sizes in a CORESET. A processing system 520 may be an example of a processing system 140 (such as of a UE 115) and may include a CORESET component 525, a REG component 530, a precoder component 535, a capability component 540, or any combination thereof. A processing system 520, or various component thereof, may be an example of means for performing (such as a means for causing a UE 115 to perform) various techniques described herein.

The CORESET component 525 may be configured to cause the UE 115 to receive control signaling configuring a CORESET including one or more REGs, where the control signaling indicates a duration of the CORESET, a time REG bundle size of the one or more REGs, and a frequency REG bundle size of the one or more REGs. The REG component 530 may be configured to cause the UE 115 to monitor, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of REs in a frequency domain in accordance with the frequency REG bundle size indicated via the control signaling. In some examples, the REG component 530 may be configured to cause the UE 115 to receive, in accordance with the monitoring, the one or more control signals via at least one REG bundle included in the CORESET.

In some examples, to support receiving the control signaling, the precoder component 535 may be configured to cause the UE 115 to receive, via the control signaling, an indication of a precoder cycling mode enabled for precoder cycling across resources within the CORESET according to a precoder cycling granularity.

In some examples, the precoder cycling mode includes a time and frequency cycling mode that enables the precoder cycling between a sequence of precoders across both the time domain and the frequency domain according to the precoder cycling granularity, the precoder cycling granularity based on both the time REG bundle size and the frequency REG bundle size.

In some examples, the precoder cycling mode includes a time cycling mode that enables the precoder cycling between a sequence of precoders across the time domain according to the precoder cycling granularity, the precoder cycling granularity based on the time REG bundle size.

In some examples, the precoder cycling mode includes a frequency cycling mode that enables the precoder cycling between a sequence of precoders across the frequency domain according to the precoder cycling granularity, the precoder cycling granularity based on the frequency REG bundle size.

In some examples, the precoder cycling mode includes an all contiguous resource cycling mode that enables the precoder cycling according to the precoder cycling granularity, the precoder cycling granularity including all contiguous time and frequency resources included in the CORESET.

In some examples, the capability component 540 may be configured to cause the UE 115 to transmit a capability message indicating a capability of the UE 115 to perform granular precoder cycling across the time domain and the frequency domain, where the control signaling is based on the capability message.

In some examples, the capability component 540 may be configured to cause the UE 115 to transmit a capability message indicating a capability of the UE 115 to monitor the one or more REGs according to both the time REG bundle size and the frequency REG bundle size, where the control signaling is based on the capability message.

In some examples, the precoder component 535 may be configured to cause the UE 115 to apply a precoder to the one or more control signals, where the precoder is selected from a sequence of precoders in accordance with a mapping between the sequence of precoders and a set of multiple REs included in the CORESET and a precoder cycling granularity, where the mapping indicates that the precoder is mapped to the at least one REG bundle via which the one or more control signals are received.

In some examples, each precoder of the sequence of precoders is mapped to a respective time resource of a set of multiple time resources in the CORESET, to a respective frequency resource of a set of multiple frequency resources in the CORESET, or to both in accordance with the precoder cycling granularity.

In some examples, to support receiving the control signaling, the CORESET component 525 may be configured to cause the UE 115 to receive radio resource control signaling configuring the CORESET and indicating one or more parameters of the CORESET.

In some examples, the CORESET includes more REs in the time domain than in the frequency domain.

In some examples, the time REG bundle size is different from the duration of the CORESET.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved communication reliability, reduced latency, improved user experience related to reduced processing, reduced power consumption, and more efficient utilization of communication resources.

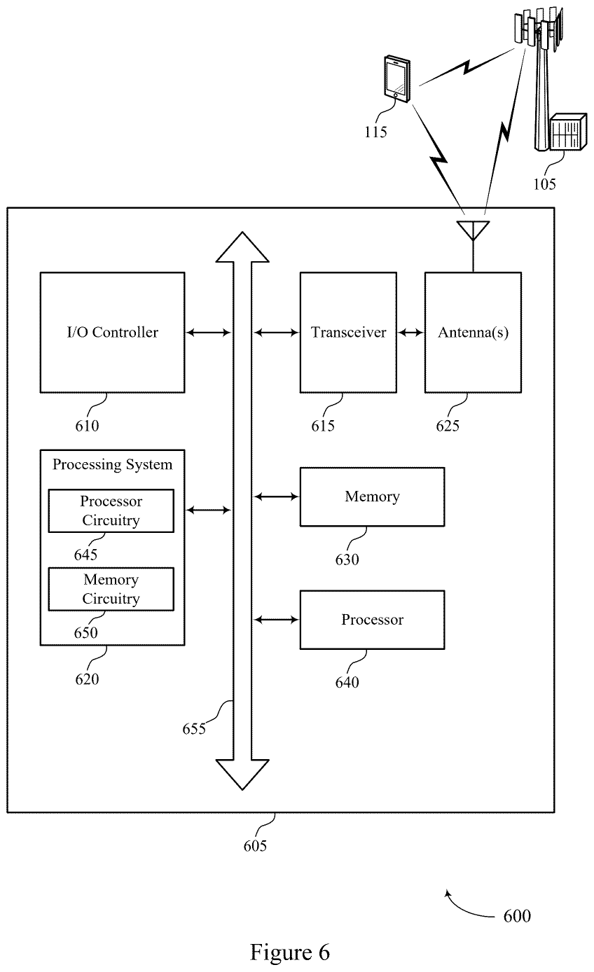

FIG. 6 shows an example of a system 600 including a device 605 that supports indication of separate time and frequency REG bundle sizes in a CORESET. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625 and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support indication of separate time and frequency REG bundle sizes in a CORESET. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof. For example, the processing system 620 may be configured to receive or transmit messages or other signaling as described herein via the transceiver 615.

By including or configuring the processing system 620 for operation in the device 605 as described herein, may support techniques for improved communication reliability, reduced latency, improved user experience related to reduced processing, reduced power consumption, and more efficient utilization of communication resources.

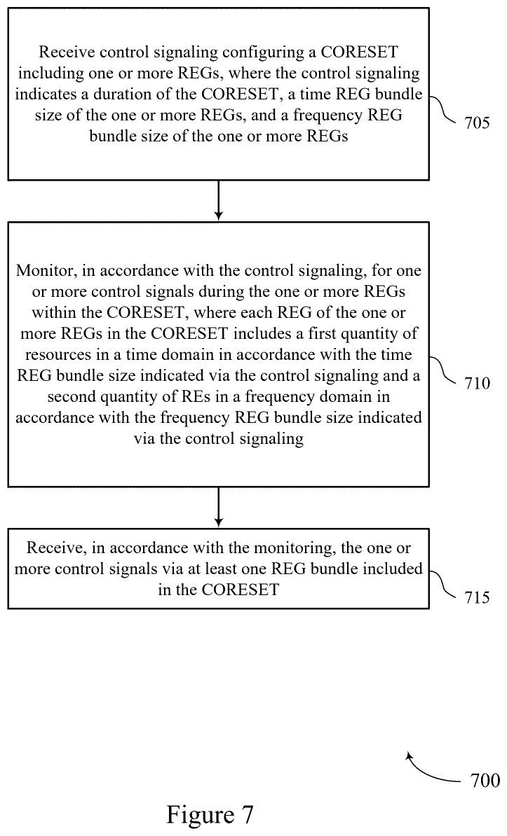

FIG. 7 shows an example of a method 700 that supports indication of separate time and frequency REG bundle sizes in a CORESET. Operations of the method 700 may be performed by a UE 115 or its components (such as using a processing system configured to cause the UE 115 to perform one or more of the operations) as described herein.

At 705, the method may include receiving control signaling configuring a CORESET including one or more REGs, where the control signaling indicates a duration of the CORESET, a time REG bundle size of the one or more REGs, and a frequency REG bundle size of the one or more REGs. In some examples, aspects of the operations of 705 may be performed by a CORESET component 525. Additionally, or alternatively, means for performing 705 may, but not necessarily, include, for example, antenna 625, transceiver 615, I/O controller 610, memory 630 (including code), processor 640, and processing system 620 (including processor circuitry 645 and/or memory circuitry 650).

At 710, the method may include monitoring, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of REs in a frequency domain in accordance with the frequency REG bundle size indicated via the control signaling. In some examples, aspects of the operations of 710 may be performed by a REG component 530. Additionally, or alternatively, means for performing 710 may, but not necessarily, include, for example, antenna 625, transceiver 615, I/O controller 610, memory 630 (including code), processor 640, and processing system 620 (including processor circuitry 645 and/or memory circuitry 650).

At 715, the method may include receiving, in accordance with the monitoring, the one or more control signals via at least one REG bundle included in the CORESET. In some examples, aspects of the operations of 715 may be performed by a REG component 530. Additionally, or alternatively, means for performing 715 may, but not necessarily, include, for example, antenna 625, transceiver 615, I/O controller 610, memory 630 (including code), processor 640, and processing system 620 (including processor circuitry 645 and/or memory circuitry 650).

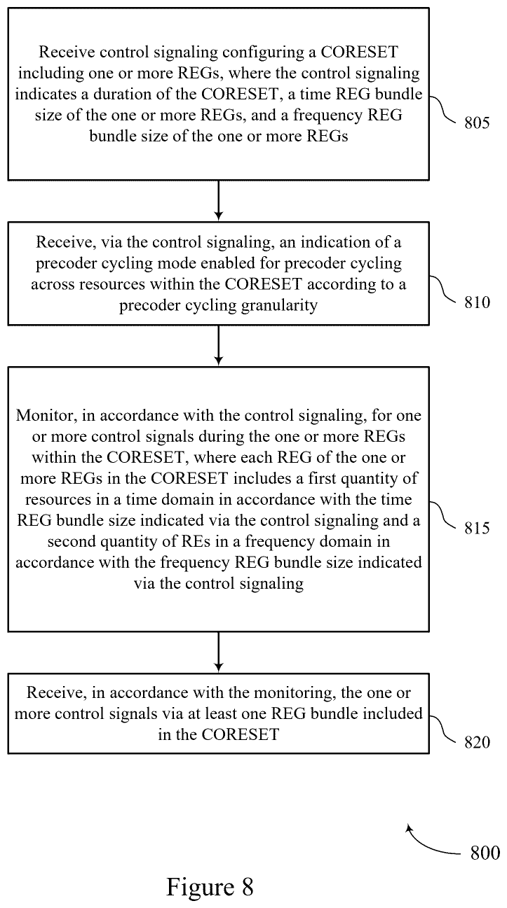

FIG. 8 shows an example of a method 800 that supports indication of separate time and frequency REG bundle sizes in a CORESET. Operations of the method 800 may be performed by a UE 115 or its components (such as using a processing system configured to cause the UE 115 to perform one or more of the operations) as described herein.

At 805, the method may include receiving control signaling configuring a CORESET including one or more REGs, where the control signaling indicates a duration of the CORESET, a time REG bundle size of the one or more REGs, and a frequency REG bundle size of the one or more REGs. In some examples, aspects of the operations of 805 may be performed by a CORESET component 525. Additionally, or alternatively, means for performing 805 may, but not necessarily, include, for example, antenna 625, transceiver 615, I/O controller 610, memory 630 (including code), processor 640, and processing system 620 (including processor circuitry 645 and/or memory circuitry 650).

At 810, the method may include receiving, via the control signaling, an indication of a precoder cycling mode enabled for precoder cycling across resources within the CORESET according to a precoder cycling granularity. In some examples, aspects of the operations of 810 may be performed by a precoder component 535. Additionally, or alternatively, means for performing 810 may, but not necessarily, include, for example, antenna 625, transceiver 615, I/O controller 610, memory 630 (including code), processor 640, and processing system 620 (including processor circuitry 645 and/or memory circuitry 650).

At 815, the method may include monitoring, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of REs in a frequency domain in accordance with the frequency REG bundle size indicated via the control signaling. In some examples, aspects of the operations of 815 may be performed by a REG component 530. Additionally, or alternatively, means for performing 810 may, but not necessarily, include, for example, antenna 625, transceiver 615, I/O controller 610, memory 630 (including code), processor 640, and processing system 620 (including processor circuitry 645 and/or memory circuitry 650).

At 820, the method may include receiving, in accordance with the monitoring, the one or more control signals via at least one REG bundle included in the CORESET. In some examples, aspects of the operations of 820 may be performed by a REG component 530. Additionally, or alternatively, means for performing 810 may, but not necessarily, include, for example, antenna 625, transceiver 615, I/O controller 610, memory 630 (including code), processor 640, and processing system 620 (including processor circuitry 645 and/or memory circuitry 650).

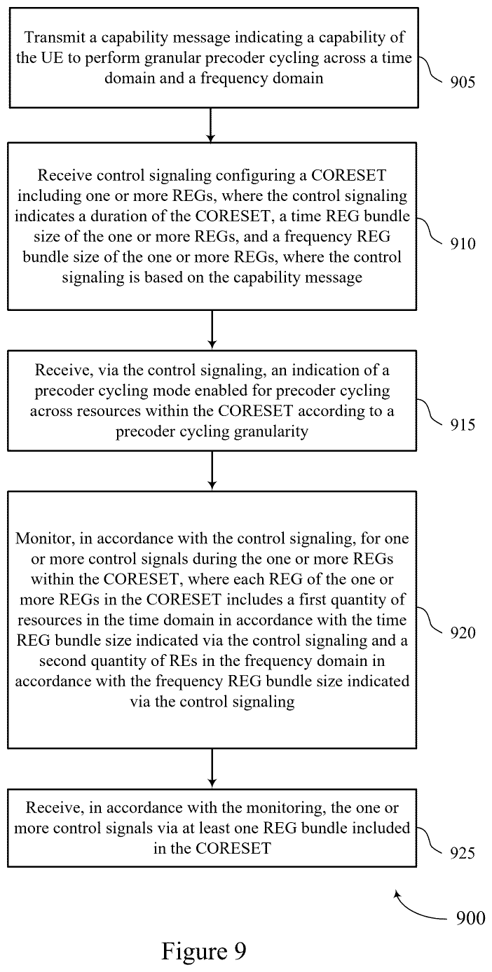

FIG. 9 shows an example of a method 900 that supports indication of separate time and frequency REG bundle sizes in a CORESET. Operations of the method 900 may be performed by a UE 115 or its components (such as using a processing system configured to cause the UE 115 to perform one or more of the operations) as described herein.

At 905, the method may include transmitting a capability message indicating a capability of the UE 115 to perform granular precoder cycling across a time domain and a frequency domain. In some examples, aspects of the operations of 905 may be performed by a capability component 540. Additionally, or alternatively, means for performing 905 may, but not necessarily, include, for example, antenna 625, transceiver 615, I/O controller 610, memory 630 (including code), processor 640, and processing system 620 (including processor circuitry 645 and/or memory circuitry 650).

At 910, the method may include receiving control signaling configuring a CORESET including one or more REGs, where the control signaling indicates a duration of the CORESET, a time REG bundle size of the one or more REGs, and a frequency REG bundle size of the one or more REGs. In some examples, the control signaling may be based on the capability message. In some examples, aspects of the operations of 910 may be performed by a CORESET component 525. Additionally, or alternatively, means for performing 910 may, but not necessarily, include, for example, antenna 625, transceiver 615, I/O controller 610, memory 630 (including code), processor 640, and processing system 620 (including processor circuitry 645 and/or memory circuitry 650).

At 915, the method may include receiving, via the control signaling, an indication of a precoder cycling mode enabled for precoder cycling across resources within the CORESET according to a precoder cycling granularity. In some examples, aspects of the operations of 915 may be performed by a precoder component 535. Additionally, or alternatively, means for performing 915 may, but not necessarily, include, for example, antenna 625, transceiver 615, I/O controller 610, memory 630 (including code), processor 640, and processing system 620 (including processor circuitry 645 and/or memory circuitry 650).

At 920, the method may include monitoring, in accordance with the control signaling, for one or more control signals during the one or more REGs within the CORESET, where each REG of the one or more REGs in the CORESET includes a first quantity of resources in the time domain in accordance with the time REG bundle size indicated via the control signaling and a second quantity of REs in the frequency domain in accordance with the frequency REG bundle size indicated via the control signaling. In some examples, aspects of the operations of 920 may be performed by a REG component 530. Additionally, or alternatively, means for performing 920 may, but not necessarily, include, for example, antenna 625, transceiver 615, I/O controller 610, memory 630 (including code), processor 640, and processing system 620 (including processor circuitry 645 and/or memory circuitry 650).

At 925, the method may include receiving, in accordance with the monitoring, the one or more control signals via at least one REG bundle included in the CORESET. In some examples, aspects of the operations of 925 may be performed by a REG component 530. Additionally, or alternatively, means for performing 925 may, but not necessarily, include, for example, antenna 625, transceiver 615, I/O controller 610, memory 630 (including code), processor 640, and processing system 620 (including processor circuitry 645 and/or memory circuitry 650).

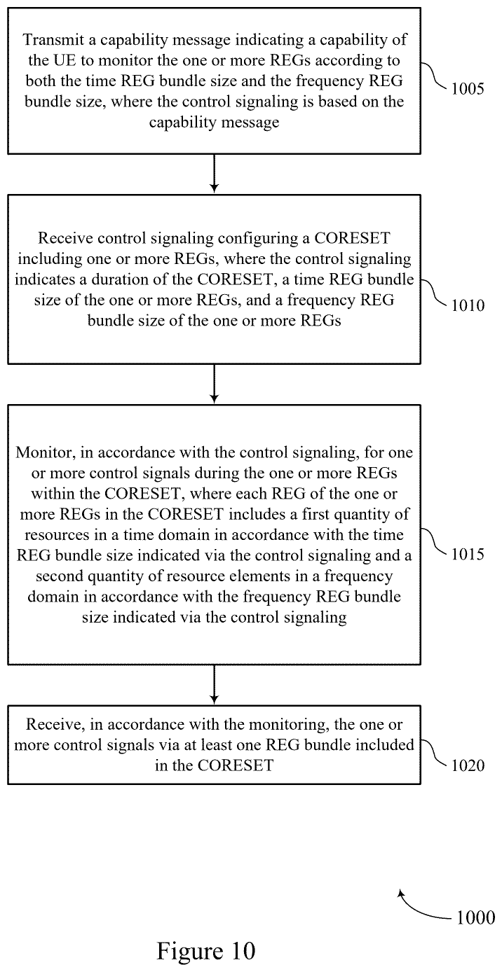

FIG. 10 shows an example of a method 1000 that supports indication of separate time and frequency REG bundle sizes in a CORESET. Operations of the method 1000 may be performed by a UE 115 or its components (such as using a processing system configured to cause the UE 115 to perform one or more of the operations) as described herein.

At 1005, the method may include transmitting a capability message indicating a capability of the UE 115 to monitor the one or more REGs according to both the time REG bundle size and the frequency REG bundle size, where the control signaling is based on the capability message. In some examples, aspects of the operations of 1005 may be performed by a capability component 540. Additionally, or alternatively, means for performing 1005 may, but not necessarily, include, for example, antenna 625, transceiver 615, I/O controller 610, memory 630 (including code), processor 640, and processing system 620 (including processor circuitry 645 and/or memory circuitry 650).

At 1010, the method may include receiving control signaling configuring a CORESET including one or more REGs, where the control signaling indicates a duration of the CORESET, a time REG bundle size of the one or more REGs, and a frequency REG bundle size of the one or more REGs. In some examples, aspects of the operations of 1010 may be performed by a CORESET component 525. Additionally, or alternatively, means for performing 1010 may, but not necessarily, include, for example, antenna 625, transceiver 615, I/O controller 610, memory 630 (including code), processor 640, and processing system 620 (including processor circuitry 645 and/or memory circuitry 650).

At 1015, the method may include monitoring, in accordance with the control signaling, for one or more control signals during the one or more REGs within the CORESET, where each REG of the one or more REGs in the CORESET includes a first quantity of resources in a time domain in accordance with the time REG bundle size indicated via the control signaling and a second quantity of REs in a frequency domain in accordance with the frequency REG bundle size indicated via the control signaling. In some examples, aspects of the operations of 1015 may be performed by a REG component 530. Additionally, or alternatively, means for performing 1015 may, but not necessarily, include, for example, antenna 625, transceiver 615, I/O controller 610, memory 630 (including code), processor 640, and processing system 620 (including processor circuitry 645 and/or memory circuitry 650).

At 1020, the method may include receiving, in accordance with the monitoring, the one or more control signals via at least one REG bundle included in the CORESET. In some examples, aspects of the operations of 1020 may be performed by a REG component 530. Additionally, or alternatively, means for performing 1020 may, but not necessarily, include, for example, antenna 625, transceiver 615, I/O controller 610, memory 630 (including code), processor 640, and processing system 620 (including processor circuitry 645 and/or memory circuitry 650).

Implementation examples are described in the following numbered clauses:

Aspect 1: A method for wireless communications at a UE, comprising: receiving control signaling configuring a CORESET comprising one or more REGs, wherein the control signaling indicates a duration of the CORESET, a time REG bundle size of the one or more REGs, and a frequency REG bundle size of the one or more REGs; monitoring, in accordance with the control signaling, for one or more control signals during the one or more REGs within the CORESET, wherein each REG of the one or more REGs in the CORESET comprises a first quantity of resources in a time domain in accordance with the time REG bundle size indicated via the control signaling and a second quantity of REs in a frequency domain in accordance with the frequency REG bundle size indicated via the control signaling; and receiving, in accordance with the monitoring, the one or more control signals via at least one REG bundle included in the CORESET.

Aspect 2: The method of aspect 1, wherein receiving the control signaling comprises: receiving, via the control signaling, an indication of a precoder cycling mode enabled for precoder cycling across resources within the CORESET according to a precoder cycling granularity.

Aspect 3: The method of aspect 2, wherein the precoder cycling mode comprises a time and frequency cycling mode that enables the precoder cycling between a sequence of precoders across both the time domain and the frequency domain according to the precoder cycling granularity, the precoder cycling granularity based at least in part on both the time REG bundle size and the frequency REG bundle size.

Aspect 4: The method of aspect 2, wherein the precoder cycling mode comprises a time cycling mode that enables the precoder cycling between a sequence of precoders across the time domain according to the precoder cycling granularity, the precoder cycling granularity based at least in part on the time REG bundle size.

Aspect 5: The method of aspect 2, wherein the precoder cycling mode comprises a frequency cycling mode that enables the precoder cycling between a sequence of precoders across the frequency domain according to the precoder cycling granularity, the precoder cycling granularity based at least in part on the frequency REG bundle size.

Aspect 6: The method of aspect 2, wherein the precoder cycling mode comprises an all contiguous resource cycling mode that enables the precoder cycling according to the precoder cycling granularity, the precoder cycling granularity comprising all contiguous time and frequency resources included in the CORESET.

Aspect 7: The method of any of aspects 2 through 6, further comprising: transmitting a capability message indicating a capability of the UE to perform granular precoder cycling across the time domain and the frequency domain, wherein the control signaling is based at least in part on the capability message.

Aspect 8: The method of any of aspects 1 through 7, further comprising: transmitting a capability message indicating a capability of the UE to monitor the one or more REGs according to both the time REG bundle size and the frequency REG bundle size, wherein the control signaling is based at least in part on the capability message.

Aspect 9: The method of any of aspects 1 through 8, further comprising: applying a precoder to the one or more control signals, wherein the precoder is selected from a sequence of precoders in accordance with a mapping between the sequence of precoders and a plurality of REs included in the CORESET and a precoder cycling granularity, wherein the mapping indicates that the precoder is mapped to the at least one REG bundle via which the one or more control signals are received.

Aspect 10: The method of aspect 9, wherein each precoder of the sequence of precoders is mapped to a respective time resource of a plurality of time resources in the CORESET, to a respective frequency resource of a plurality of frequency resources in the CORESET, or to both in accordance with the precoder cycling granularity.

Aspect 11: The method of any of aspects 1 through 10, wherein receiving the control signaling comprises: receiving radio resource control signaling configuring the CORESET and indicating one or more parameters of the CORESET.

Aspect 12: The method of any of aspects 1 through 11, wherein the CORESET comprises more REs in the time domain than in the frequency domain.

Aspect 13: The method of any of aspects 1 through 12, wherein the time REG bundle size is different from the duration of the CORESET.

Aspect 14: A UE for wireless communications, comprising a transceiver, and a processing system that includes processor circuitry and memory circuitry that stores code, the processing system configured to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a transceiver; and
a processing system that includes processor circuitry and memory circuitry that stores code, the processing system configured to cause the UE to:
receive, via the transceiver, control signaling configuring a control resource set comprising one or more resource element groups, wherein the control signaling indicates a duration of the control resource set, a time resource element group bundle size of the one or more resource element groups, and a frequency resource element group bundle size of the one or more resource element groups;
monitor, in accordance with the control signaling, for one or more control signals during the one or more resource element groups within the control resource set, wherein each resource element group of the one or more resource element groups in the control resource set comprises a first quantity of resources in a time domain in accordance with the time resource element group bundle size indicated via the control signaling and a second quantity of resource elements in a frequency domain in accordance with the frequency resource element group bundle size indicated via the control signaling; and
receive, via the transceiver, in accordance with the monitoring, the one or more control signals via at least one resource element group bundle included in the control resource set.

2. The UE of claim 1, wherein, to receive the control signaling, the processing system is configured to cause the UE to:
receive, via the transceiver and the control signaling, an indication of a precoder cycling mode enabled for precoder cycling across resources within the control resource set according to a precoder cycling granularity.

3. The UE of claim 2, wherein the precoder cycling mode comprises a time and frequency cycling mode that enables the precoder cycling between a sequence of precoders across both the time domain and the frequency domain according to the precoder cycling granularity, the precoder cycling granularity based at least in part on both the time resource element group bundle size and the frequency resource element group bundle size.

4. The UE of claim 2, wherein the precoder cycling mode comprises a time cycling mode that enables the precoder cycling between a sequence of precoders across the time domain according to the precoder cycling granularity, the precoder cycling granularity based at least in part on the time resource element group bundle size.

5. The UE of claim 2, wherein the precoder cycling mode comprises a frequency cycling mode that enables the precoder cycling between a sequence of precoders across the frequency domain according to the precoder cycling granularity, the precoder cycling granularity based at least in part on the frequency resource element group bundle size.

6. The UE of claim 2, wherein the precoder cycling mode comprises an all contiguous resource cycling mode that enables the precoder cycling according to the precoder cycling granularity, the precoder cycling granularity comprising all contiguous time and frequency resources included in the control resource set.

7. The UE of claim 2, wherein the processing system is further configured to cause the UE to:
transmit, via the transceiver, a capability message indicating a capability of the UE to perform granular precoder cycling across the time domain and the frequency domain, wherein the control signaling is based at least in part on the capability message.

8. The UE of claim 1, wherein the processing system is further configured to cause the UE to:
transmit, via the transceiver, a capability message indicating a capability of the UE to monitor the one or more resource element groups according to both the time resource element group bundle size and the frequency resource element group bundle size, wherein the control signaling is based at least in part on the capability message.

9. The UE of claim 1, wherein the processing system is further configured to cause the UE to:
apply a precoder to the one or more control signals, wherein the precoder is selected from a sequence of precoders in accordance with a mapping between the sequence of precoders and a plurality of resource elements included in the control resource set and a precoder cycling granularity, wherein the mapping indicates that the precoder is mapped to the at least one resource element group bundle via which the one or more control signals are received.

10. The UE of claim 9, wherein each precoder of the sequence of precoders is mapped to a respective time resource of a plurality of time resources in the control resource set, to a respective frequency resource of a plurality of frequency resources in the control resource set, or to both in accordance with the precoder cycling granularity.

11. The UE of claim 1, wherein, to receive the control signaling, the processing system is configured to cause the UE to:
receive, via the transceiver, radio resource control signaling configuring the control resource set and indicating one or more parameters of the control resource set.

12. The UE of claim 1, wherein the control resource set comprises more resource elements in the time domain than in the frequency domain.

13. The UE of claim 1, wherein the time resource element group bundle size is different from the duration of the control resource set.

14. A method for wireless communications at a user equipment (UE), comprising:
receiving control signaling configuring a control resource set comprising one or more resource element groups, wherein the control signaling indicates a duration of the control resource set, a time resource element group bundle size of the one or more resource element groups, and a frequency resource element group bundle size of the one or more resource element groups;
monitoring, in accordance with the control signaling, for one or more control signals during the one or more resource element groups within the control resource set, wherein each resource element group of the one or more resource element groups in the control resource set comprises a first quantity of resources in a time domain in accordance with the time resource element group bundle size indicated via the control signaling and a second quantity of resource elements in a frequency domain in accordance with the frequency resource element group bundle size indicated via the control signaling; and
receiving, in accordance with the monitoring, the one or more control signals via at least one resource element group bundle included in the control resource set.

15. The method of claim 14, wherein receiving the control signaling comprises:
receiving, via the control signaling, an indication of a precoder cycling mode enabled for precoder cycling across resources within the control resource set according to a precoder cycling granularity.

16. The method of claim 15, wherein the precoder cycling mode comprises a time and frequency cycling mode that enables the precoder cycling between a sequence of precoders across both the time domain and the frequency domain according to the precoder cycling granularity, the precoder cycling granularity based at least in part on both the time resource element group bundle size and the frequency resource element group bundle size.

17. The method of claim 15, wherein the precoder cycling mode comprises a time cycling mode that enables the precoder cycling between a sequence of precoders across the time domain according to the precoder cycling granularity, the precoder cycling granularity based at least in part on the time resource element group bundle size.

18. The method of claim 15, wherein the precoder cycling mode comprises a frequency cycling mode that enables the precoder cycling between a sequence of precoders across the frequency domain according to the precoder cycling granularity, the precoder cycling granularity based at least in part on the frequency resource element group bundle size.

19. The method of claim 15, wherein the precoder cycling mode comprises an all contiguous resource cycling mode that enables the precoder cycling according to the precoder cycling granularity, the precoder cycling granularity comprising all contiguous time and frequency resources included in the control resource set.

20. A non-transitory computer-readable medium storing code for wireless communications, the code comprising instructions executable by one or more processors to:
receive control signaling configuring a control resource set comprising one or more resource element groups, wherein the control signaling indicates a duration of the control resource set, a time resource element group bundle size of the one or more resource element groups, and a frequency resource element group bundle size of the one or more resource element groups;
monitor, in accordance with the control signaling, for one or more control signals during the one or more resource element groups within the control resource set, wherein each resource element group of the one or more resource element groups in the control resource set comprises a first quantity of resources in a time domain in accordance with the time resource element group bundle size indicated via the control signaling and a second quantity of resource elements in a frequency domain in accordance with the frequency resource element group bundle size indicated via the control signaling; and
receive, in accordance with the monitoring, the one or more control signals via at least one resource element group bundle included in the control resource set.
